(19) United States
(12) Patent Application Publication
(10) Pub. No.: US 2015/0337997 A1
(43) Pub. Date: Nov. 26, 2015

(54) FLEXIBLE PLASTIC IRRIGATION TUBING

(71) Applicant: RELIANCE WIRE & CABLE, LLC, SCOTTSDALE, AZ (US)

(72) Inventor: JUAN EDUARDO KLADT SOBRINO, SCOTTSDALE, AZ (US)

(21) Appl. No.: 14/717,722

(22) Filed: May 20, 2015

Related U.S. Application Data
(60) Provisional application No. 62/001,227, filed on May 21, 2014.

(51) Int. Cl. F16L 11/15

(52) U.S. Cl. CPC F16L 11/15

(57) ABSTRACT

A conduit for a sprinkler system has a flexible conduit having a plurality of parallel rib members forming a corrugated tubing. A plurality of tapered members is positioned along predetermined lengths of the flexible conduit.

### RELATED APPLICATIONS

The present patent application claims the benefit of U.S. Provisional Application No. 62/001,227, filed May 21, 2014, entitled “Flexible Plastic Irrigation Tubing” in the name of the same inventor, and which is incorporated herein by reference in its entirety. The present patent application claims the benefit under 35 U.S.C. §119(e).

### TECHNICAL FIELD

The invention relates generally to a sprinkler system, and more particularly, to a flexible conduit for an irrigation/sprinkler system which may change direction and heights without kinking and without the use of couplings and which may be more easily connected to a coupling and or elbow than prior art conduits.

### BACKGROUND

Poly tubing is lightweight, flexible and generally does not require glue to assemble, making it desirable for use in many outdoor plumbing projects. It is not suitable for high-pressure applications, but it is safe to use as a low-pressure water line, such as those used for underground irrigation systems. It cannot be connected to the sprinklers or valves directly, requiring a barbed adapter to join the tubing to the pipe threads commonly used in irrigation systems.

While poly tubing is flexible, poly tubing may form a kink if sharp curves are attempted. The kinks formed in the poly tubing may prevent water flow or severely limit the water flow through the poly tubing. In order to make sharp turns, change the directing of the poly tubing or connect multiple pieces of poly tubing together, different couplings or elbows are generally required to be used.

In order to connect the poly tubing to a coupling or an elbow, the user generally has to exert a tremendous amount of force to insert the poly tubing into the opening of the coupling and or elbow. Thus, it is very time consuming and tiring to connect poly tubing to a coupling and or elbow.

Therefore, it would be desirable to provide a system and method that overcomes the above.

### SUMMARY

In accordance with one embodiment, a conduit for a sprinkler system is disclosed. The conduit is a flexible conduit having a plurality of parallel rib members forming a corrugated tubing. A plurality of tapered members is positioned along predetermined lengths of the flexible conduit.

In accordance with one embodiment, a conduit for a sprinkler system is disclosed. The conduit is a flexible conduit having a plurality of rib members forming a corrugated tubing. A plurality of smooth areas is positioned along predetermined lengths of the flexible conduit.

In accordance with one embodiment, a conduit for a sprinkler system is disclosed. The conduit is a flexible conduit having a plurality of rib members forming a corrugated tubing. A plurality of smooth areas positioned along predetermined lengths of the flexible conduit. Each of the smooth areas is tapered. Each of the plurality of smooth areas has a first diameter at each outer end and a second diameter at a central area, wherein the second diameter is smaller than the first diameter.

The features, functions, and advantages may be achieved independently in various embodiments of the disclosure or may be combined in yet other embodiments.

### BRIEF DESCRIPTION OF DRAWINGS

Embodiments of the disclosure will become more fully understood from the detailed description and the accompanying drawings, wherein:

FIG. 1 is a perspective view of prior art tubing used in irrigation systems;

FIG. 2 is a perspective view of the flexible tubing of the present invention;

FIG. 3 is a side view of the flexible tubing of FIG. 2;

FIG. 4 is another perspective view of the flexible tubing of FIG. 2 showing how the flexible tubing may change directions and heights without couplings;

FIG. 5 is another perspective view of the flexible tubing of FIG. 2 showing how the flexible tubing is attachable to different connectors;

FIG. 6 is another perspective view of the flexible tubing of FIG. 2 showing how the flexible tubing is cut to attach the flexible tubing to different connectors;

FIG. 7 is another perspective view of the flexible tubing of FIG. 2 showing how the cut flexible tubing is attachable to different connectors; and

FIG. 8 is another perspective view of the flexible tubing of FIG. 2 showing how the flexible tubing is attachable to different connectors.

### DESCRIPTION OF THE APPLICATION

The description set forth below in connection with the appended drawings is intended as a description of presently preferred embodiments of the application and is not intended to represent the only forms in which the present application can be constructed and/or utilized. The description sets forth the functions and the sequence of steps for constructing and operating the application in connection with the illustrated embodiments. It is to be understood, however, that the same or equivalent functions and sequences can be accomplished by different embodiments that are also intended to be encompassed within the spirit and scope of this application.

As shown in FIG. 1, a prior art tubing 10 is shown. The tubing 10 is a poly tubing which may be used in many outdoor plumbing projects such as irrigation and or sprinkler systems. While the tubing 10 may be flexible, the tubing 10 is limited as to the angle the tubing may be bent. As may be seen in FIG. 1, if the tubing 10 is bent at too sharp an angle, a kink 12 may form in the tubing 10. If a kink 12 is formed in the tubing 10, water flow through the tubing 10 may be prevented and or severely limited.

As disclosed above, in order to make sharp turns, change the directing of the tubing 10 or connect multiple pieces of tubing 10 together, different couplings or elbows are generally required to be used. In order to connect the tubing 10 to a coupling or an elbow, the user generally has to exert a tremendous amount of force to insert the tubing 10 into the opening of the coupling and or elbow. Thus, it is very time consuming and tiring to connect tubing 10 to a coupling and or elbow.

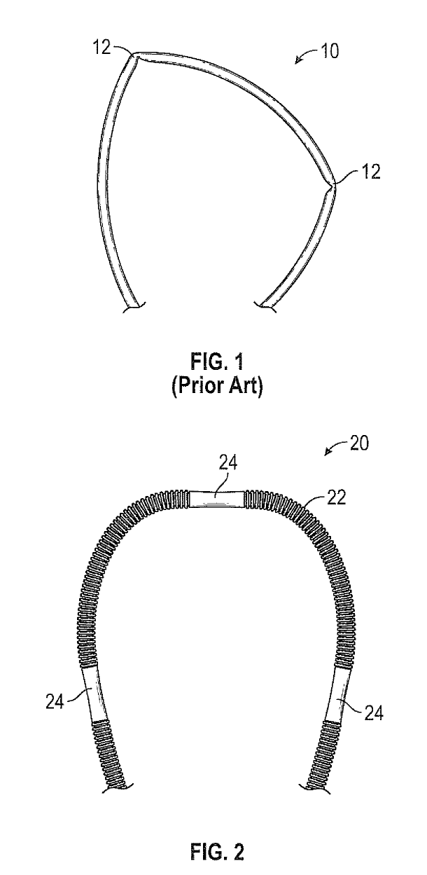

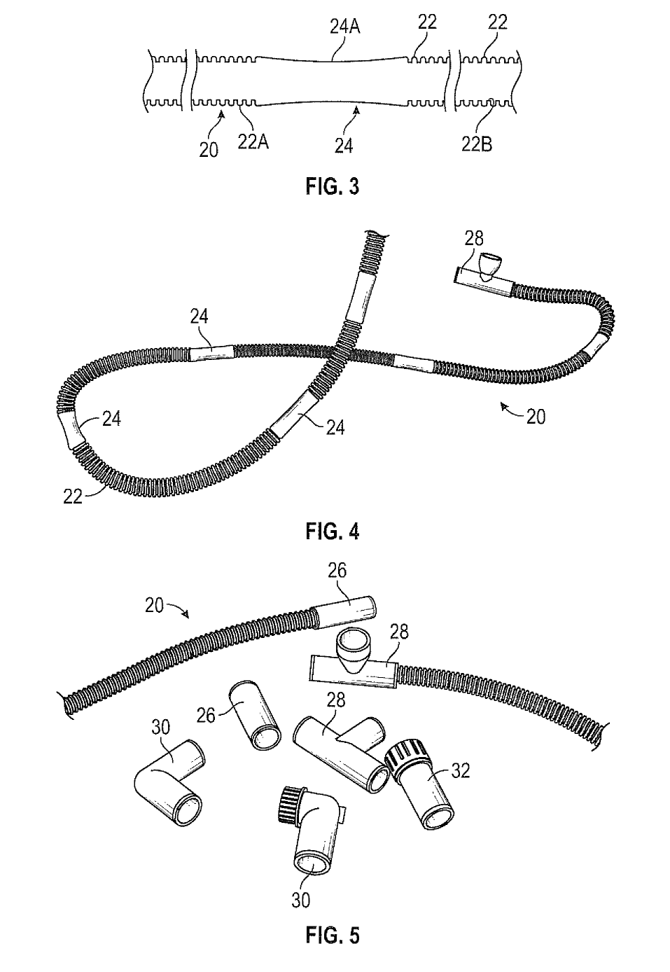

Referring to FIGS. 2-8, a flexible tubing 20 of the present invention will be described. The flexible tubing 20 may allow turns and or bends of any angle without kinks being formed or other damage to the flexible tubing 20. The flexible tubing 20 may thus provide a great advantage for landscapers & agriculture applications since it eliminates the use of couplings and or elbows. By limiting the number of couplings and or elbows, the amount of pressure loss within the flexible tubing 20 may be reduced.

The flexible tubing 20 may be a plastic tubing having a plurality of rib members 22. The rib members 22 forma plurality of parallel ridges thereby forming the flexible tubing 20 into corrugated tubing. The rib members 22 may allow the flexible tubing 20 to bend at different angles without kinking or damaging the flexible tubing 20. As may be seen in FIG. 4, the flexible tubing 20 allows for the changing directions or heights during installation without kinking and without having to use any couplings or elbows.

The flexible tubing 20 may have a plurality of tapered sections 24. The tapered sections 24 are formed of the same flexible plastic as the flexible tubing 20. However, the tapered section 24 have a smooth exterior surface and do not have the rib members 22. The tapered sections 24 are initially approximately a same size in diameter as the flexible tubing 20 but taper to a smaller diameter towards a central area 24A of the tapered section 24. Thus, the tapered section 24 may be hourglass shaped. However, the central area 24 may be only slightly smaller in diameter. In accordance with one embodiment, the initial diameter of the tapered section is approximately the same diameter as a top section 22A of the rib members 22. The diameter of the tapered section 24 gradually reduces to the central area 24A where the diameter is approximately the same diameter as a bottom section 22B of the rib member. In accordance with one embodiment, the diameter of the central area 24A is approximately 0.048″. The tapered sections 24 may be used to connect the flexible tubing 20 to different connectors and or elbows as will be described below.

As may be seen in FIGS. 4-5, the flexible tubing 20 may be coupled to existing irrigation components. The flexible tubing 20 may be coupled to straight connectors 26, “T” connectors 28, elbow connectors 30, end caps 32 and the like. In the irrigation industry, connectors may be identified as blue ring parts & black ring parts for ease of identification. The flexible tubing 20 may work with both types when the tapered section 24 may be used as a connection section.

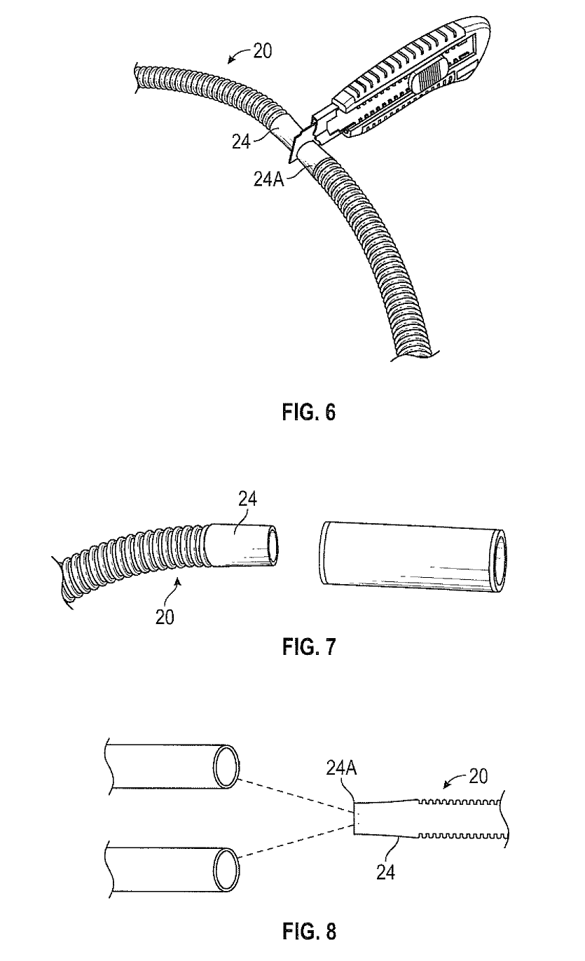

Referring to FIGS. 6 and 7, to use the tapered section 24 as a connector, a user may cut the tapered section 24 with a knife as shown in FIG. 6. In general, the user should cut the tapered section 24 towards the central area 24A of the tapered section 24. Each cut end of the tapered section 24 may then be easily inserted into connectors as shown in FIG. 7.

As may be seen in FIG. 8, blue ring parts may have a diameter of 0.632″ while a black ring part may have a diameter of 0.620″. The cut end of the tapered section 24 may easily fit into either a blue ring part or a black ring part. Since the diameter of the tapered section 24 grows larger as the tapered sections moves outward from the central area 24A, the tapered sections 24 will form a tight fit within an opening of either the blue ring part or the black ring part

While embodiments of the disclosure have been described in terms of various specific embodiments, those skilled in the art will recognize that the embodiments of the disclosure may be practiced with modifications within the spirit and scope of the claims.

1. A conduit for a sprinkler system comprising:
a flexible conduit having a plurality of parallel rib members forming a corrugated tubing; and
a plurality of tapered members positioned along predetermined lengths of the flexible conduit.

2. The flexible conduit of claim 1, wherein each of the plurality of tapered members has an approximately smooth exterior surface.

3. The flexible conduit of claim 1, wherein each of the plurality of tapered members has a first diameter at each outer end and a second diameter at a central area, wherein the second diameter is smaller than the first diameter.

4. The flexible conduit of claim 1, wherein each of the plurality of tapered members has a first diameter at each outer end and a second diameter at a central area, wherein the first diameter is approximately equal to a diameter of the flexible conduit along a top edge of a rib member and the second diameter is approximately equal to a bottom edge of the rib member.

5. The flexible conduit of claim 1, wherein at least one of the tapered sections is cut for insertion into an irrigation component.

6. The flexible conduit of claim 1, wherein at least one of the tapered sections is cut for insertion into one of: a straight connectors, a “T” connectors, an elbow connector, or an end cap.

7. The flexible conduit of claim 1, wherein at least one of the tapered sections is cut for insertion into either a blue ring irrigation part or a black ring irrigation part.

8. A conduit for a sprinkler system comprising:
a flexible conduit having a plurality of rib members forming a corrugated tubing; and
a plurality of smooth areas positioned along predetermined lengths of the flexible conduit.

9. The flexible conduit of claim 8, wherein each of the plurality of smooth areas is tapered.

10. The flexible conduit of claim 9, wherein each of the plurality of smooth areas has a first diameter at each outer end and a second diameter at a central area, wherein the second diameter is smaller than the first diameter.

11. The flexible conduit of claim 9, wherein each of the plurality of smooth areas has a first diameter at each outer end and a second diameter at a central area, wherein the first diameter is approximately equal to a diameter of the flexible conduit along a top edge of a rib member and the second diameter is approximately equal to a bottom edge of the rib member.

12. The flexible conduit of claim 9, wherein at least one of the smooth areas is cut for insertion into an irrigation component.

13. The flexible conduit of claim 9, wherein at least one of the smooth areas is cut for insertion into one of: a straight connectors, a “T” connectors, an elbow connector, or an end cap.

14. The flexible conduit of claim 9, wherein at least one of the smooth areas is cut for insertion into either a blue ring irrigation part or a black ring irrigation part.

15. A conduit for a sprinkler system comprising:
a flexible conduit having a plurality of rib members forming a corrugated tubing; and
a plurality of smooth areas positioned along predetermined lengths of the flexible conduit, wherein each of the smooth areas is tapered, each of the plurality of smooth areas has a first diameter at each outer end and a second diameter at a central area, wherein the second diameter is smaller than the first diameter.

16. The flexible conduit of claim 15, wherein the first diameter is approximately equal to a diameter of the flexible conduit along a top edge of a rib member and the second diameter is approximately equal to a bottom edge of the rib member.

17. The flexible conduit of claim 15, wherein at least one of the smooth areas is cut for insertion into an irrigation component.

18. The flexible conduit of claim 15, wherein at least one of the smooth areas is cut for insertion into one of: a straight connectors, a “T” connectors, an elbow connector, or an end cap.

19. The flexible conduit of claim 15, wherein at least one of the smooth areas is cut for insertion into either a blue ring irrigation part or a black ring irrigation part.
